(19) United States
(12) Patent Application Publication
(10) Pub. No.: US 2010/0057746 A1
(43) Pub. Date: Mar. 4, 2010

(54) VIRTUAL REPRESENTATION

(76) Inventors: Gary BROWN, Hitchin (GB); Vivien BROWN, Hitchin (GB); Pauline BROWN, Northleach (GB); David BROWN, Northleach (GB)

Correspondence Address: Workman Nydegger;1000 Eagle Gate Tower, 60 East South Temple, Salt Lake City, UT, 84111, US

(21) Appl. No.: 12/201,836

(22) Filed: Aug. 29, 2008

(51) Int. Cl. G06F 17/30

(52) U.S. Cl. 707/10; 707/E17.055

(57) ABSTRACT

A computer implemented method provides a way of storing custom access control rules with information to which they apply. The rules can be associated with individual pieces of information, to provide a finer grained level of access without the need for prior knowledge of all potential entities that may access the information. The stored data and access control rules may be associated with a virtual representation of an entity, which may be one of many virtual representations of different entities managed within a globally accessible and federated information store. The access control rules can be based on querying information associated with the virtual representation of a requesting party, or information accessible by navigating relationships associated with that virtual representation, thereby providing great flexibility.

### FIELD OF THE INVENTION

The present invention relates to a method for controlling access to stored data by association with a set of stored access control rules and use of the method to mediate a system for virtual representation of entities and associated data.

### BACKGROUND OF THE INVENTION

The internet revolution has changed the way people and businesses function. A significant percentage of people within developed countries have internet connectivity and conduct many aspects of their life through this medium. However, as with many concepts that are rapidly adopted, scalability starts to become an issue. In this regard, we are not referring to performance but more to the nature in which people deal with each other and organisations over the internet.

The traditional approach for an individual to interact with websites is that they are required to register with them, possibly building up a profile of information and perhaps, depending upon the nature of the site, provide payment details (e.g. credit or debit cards related information). This means that each website has a subset of information about an individual, but it also means that the individual may have hundreds of registered profiles on different websites.

This traditional approach to interacting with such websites leads to an individual having to maintain a significant number of usernames and passwords associated with these many sites, and therefore the security issue results in a burden on the individual. For example, the individual must consider whether or not to use a single username and password for all website. If a single username and password is used, and the details become known, then there is a risk that the individual is potentially compromised, which in turn requires that individual has to access each of the affected websites to change the password.

Alternatively, the individual may choose to use multiple usernames and passwords, but then this becomes hard to manage, resulting in those usernames and passwords having to be recorded somewhere, which could equally become compromised. Finally, if the same username and password is used on many sites, and employees of one company have access to the details on their company's computers, then they may try other well known sites to see if the same details work on them.

There are also other computer systems that record information about an individual, and that are not directly accessible by that individual. Examples include government departments, such as the Inland Revenue, National Health Service, and other UK government departments. In recent times, there have been a number of widely publicised security lapses in the UK with government managed information, whereby information such as individual's bank details have become available. The lapses typically arise as a result of the need to transfer information between different departments.

When information is fragmented and stored in many different computers, this leads to inconsistencies and less effective use of the information. It also leads to security issues when that information has to be transferred between sites. With the present approach, the number of places where an individual's information may be recorded will only grow in the future. The present approach is simply not a scalable solution.

Some of the security issues mentioned above can be solved using digital signature public/private key authentication. Using this technique an individual uses a private key only they know to ‘sign’ information, which can then be authenticated by another party using the publicly available key for that individual. This approach would avoid individual's having usernames and passwords on websites. However, this does not overcome the issue of the fragmented information about an individual being located on many websites, or the security of personal information, such as credit card details on those sites. It also does not solve the publicised problems related to transferring sensitive information between government agencies. Moreover, this approach to security has not been widely adopted on the internet.

Whether username/passwords or digital signatures are used, this only provides a limited capability for determining whether a particular interested party has the appropriate access privileges to stored information. The current state of the art is to provide an ‘access control list’ based on a map that directly or indirectly links the user credentials with the function they are permitted to perform on a database.

However, when dealing with a large scale information store, where the number of entities (individuals or organisations) that may need to access specific information could be very large, it is impractical to store mappings for all of the individual entities.

One approach to this problem is to use the trust relationships associated with an entity requesting access to the information, to determine whether they can be granted access. For example, if an employee of a particular company wishes to access the information, and that employee has a trust relationship with the organisation, and the information can be accessed by entities that the company trusts, then the employee will be granted access to the information. The access control rules for the information only need to indicate the relationship to the organisation, not to each of the individual employees.

However, trust relationships are not a general enough mechanism to cope with the scale of the problem. What is required is a means to define access control rules that can interrogate any relevant information about the requesting entity. This is only possible if the information about the requesting entity is managed in a secure and centrally accessible information repository.

Thus, there is a need for a solution to the problems outlined above, whereby information about a large number entities can be managed in a secure manner and one that is scalable. If a suitable mechanism could be found, it would most likely encourage the wider use of public/private keys by individuals and organisations, and therefore indirectly improve security on the internet as a side effect.

### SUMMARY OF THE INVENTION

According to the present invention, a computer implemented method of governing access to data stored in an electronic data store comprises the steps of:

receiving from a first entity the data and a set of access control rules to govern access rights to the data; and,

storing the data together with the set of access control rules in the electronic data store, such that any subsequent attempt to access the stored data is governed by access control rules in the stored set associated with the stored data.

Preferably, the method further comprises the steps of:

subsequently receiving a request from a second entity for access to the data in the data store; and,

granting to the second entity access rights to the data in accordance with access control rules in the stored set associated with the data in dependence on information associated with the second entity.

In a preferred embodiment, the stored data and access control rules are associated with a virtual representation of a third entity, which may be an individual, an organisation or other legal entity. The third entity may also request access to the data in the data store and be granted access rights to the data in accordance with access control rules in the stored set associated with the data in dependence on information associated with the third entity.

Preferably, the virtual representation is referenced by means of a unique identifier, which may be a universal resource locator (URL) over a communications network. The unique identifier may be obtainable by means of a query based on public information in the virtual representation of the third entity.

The stored data may represent relationships between the virtual representation of the third entity and virtual representations of other entities. In a preferred aspect of the invention, the third entity is one of many virtual representations of different entities managed by a fourth entity within a globally accessible and federated information store.

Preferably, the method further comprises the steps of:

subsequently receiving a request from another entity to associate further data with the virtual representation of the third entity; and,

granting to the other entity create rights to associate the further data and any related access control rules with the virtual representation of the third entity in accordance with create rules associated with the virtual representation of the third entity.

The further data may represent relationships between the virtual representation of the third entity and virtual representations of other entities. If no create rules apply, the method further comprises the step of contacting the third party for manual approval to associate the further data and any related access control rules with the virtual representation of the third party.

According to the present invention, a system for managing and providing access to virtual representations of entities comprises:

a plurality of globally federated and replicated servers, the servers being located in one or more different domains;

a plurality of data stores associated with the servers, the data stores being located in the one or more different domains,

wherein the plurality of servers and data stores are adapted to implement the method of the present invention.

In a preferred embodiment, the different domains are different national jurisdictions and the servers and data stores located in each different national jurisdiction are managed by an official agency of that national jurisdiction.

The present invention is set within the context of a facility to enable a first party (viz. the fourth entity) to manage virtual representations of second parties (viz. the third entity), within a globally accessible and federated information store, where third parties (viz. the first entity) are permitted to associate information with the second party's virtual representation along with access control rules to govern whether other fourth parties (viz. the second entity) have rights over the information. Such rights may include read, update and delete rights, and permission will be subject to their agreement or based on pre-configured ‘create’ rules associated with the second party's virtual representation. The third party has full rights to the information it associates with the second party.

The invention addresses the issue of storing custom access control rules with information to which they apply. The access control rules can query the properties associated with the virtual representation of the entity requesting access to the information. For example, a virtual representation for a person may have their medical records associated with them, with access control rules indicating that they can be read and updated by the person's GP or any doctor that works in a hospital.

Due to the general nature of the access control rules, it means that the rules can be associated with individual pieces of information, to provide a finer grained level of access without having to have prior knowledge of all potential entities that may access the information. This type of approach is necessary when information needs to be accessible on a global scale.

The first aspect of the invention is the ability for information being recorded within an information store to be accompanied by access control rules, provided by the information writer, to govern what rights other entities may have when accessing the information in subsequent requests. One embodiment of this would be access control rules recorded with a record (row) within a relational database (RDBMS). Another embodiment would be access control rules encapsulated with an object stored within an object database (ODBMS). The rules need not be internal to the object. They may be stored externally, provided they are bound to or associated with the object in some manner.

The current state of the art is record (or row) level access control within a relational database. However, in this case the rules are configured as part of the relational table definition, by the database designer or administrator (DBA), and therefore the same rules are common to all rows within the table. In contrast, the present invention relates to the ability to store different access control rules with each row, where the rules are provided by the entity storing the record/row.

The set of access rights will include, but are not limited to, the ability to read, update and delete the information.

When accessing the information recorded by the third party, the second party would be treated in the same manner as a fourth party. They do not have implicit right to access the information associated with their own virtual representation, unless the rules established by the third party grant access privileges to the second party.

The information may be represented in any structured or unstructured format, suitable to be understood by the third party and any fourth parties that are allowed to read and update the information.

The information may represent relevant facts related to the second party, or relationships between the second party and other virtual representations.

Another aspect of the invention relates to the fact that access control rules can be based on querying information associated with the requesting party's virtual representation, or information accessible by navigating relationships associated with the requesting party's virtual representation.

The virtual representation of a second party can be referenced using a unique identifier, equivalent to the concept of a URL that might be used to locate a website. This unique identifier can be passed between co-operating distributed applications. For example, an individual supplies their own virtual representation reference when accessing a DVD sales website and the reference is then passed by the website to a payment processor to complete the transaction.

The unique identifier for a second party's virtual representation can be obtained using a query based on public information in the second party's virtual representation, as well as other information associated with the second party's virtual representation which is accessible by the requesters virtual representation. The queries can also navigate available relationships from the second party to other virtual representations.

Modifications to a virtual representation, or information/relationships associated with a virtual representation, will be recorded in an audit trail.

As will be appreciated by those skilled in the art, the present invention addresses a number of specific problems of known systems, and enables a mechanism for dealing with the situation of globally relevant information about individuals and organisations. Currently, databases only permit rules to be setup as part of the database or table configuration, and therefore they apply to all information stored within the database or table. The present invention enables custom access control rules to be stored with the information they will protect.

Another specific problem addressed by the invention is how to make information in a database secure, and only accessible to appropriate entities (individuals or organisations), when the number of potential entities is too large to be managed on the basis of being an individual or on the basis of simple classifications (i.e. groups).

By enabling access control rules to be defined, based on characteristics of the requesting entity, it allows simple rules to encapsulate access privileges that may actually encompass many entities (individuals or organisations), without the database having prior knowledge of the requesting entities. This simplifies the administration of access control rules associated with the information, without having to define exhaustive lists of entities that have access privileges.

The mechanism of the present invention will be essential when dealing with information stores that contain globally relevant information about individuals and organisations, where that information needs to be protected and only read or updated by other entities that meet specific requirements.

### BRIEF DESCRIPTION OF THE DRAWINGS

Examples of the present invention will now be described in detail with reference to the accompanying drawings, in which:

FIG. 1 shows a flowchart illustrating the manipulation of information associated with an entity;

FIG. 2 shows a flowchart illustrating the process by which information or a relationship is associated; and,

FIG. 3 illustrates a system of globally federated and replicated servers and data stores for providing access to virtual representations of entities.

### DETAILED DESCRIPTION

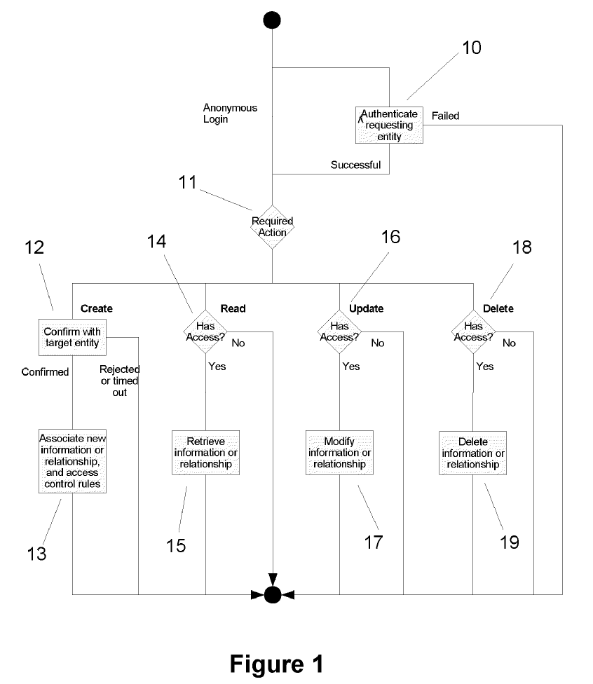

We now consider the operation of the invention in more detail, and in particular the various processes for manipulating and associating data with entities, and the subsequent querying of the data and associated relationships. These are illustrated in FIGS. 1 to 3.

Manipulating Information Associated with an Individual or Organisation

As shown in FIG. 1, a requesting entity (i.e. an individual or organisation) can either login anonymously, or be authenticated (10), depending on the nature of the operation they wish to perform on the target entity (i.e. individual/organisation) (hence forth referred to simply as ‘the target’). For example, if they only wish to read publicly accessible information about the target, then they do not need to be authenticated. However, if they wish to read private (secure) information, then they will need to be authenticated and also have the appropriate access privileges to read the requested information.

The next step depends upon the ‘right’ (11) that is being checked. FIG. 1 only shows a subset of the possible ‘rights’ that may be available for illustration purposes. These will be discussed in turn.

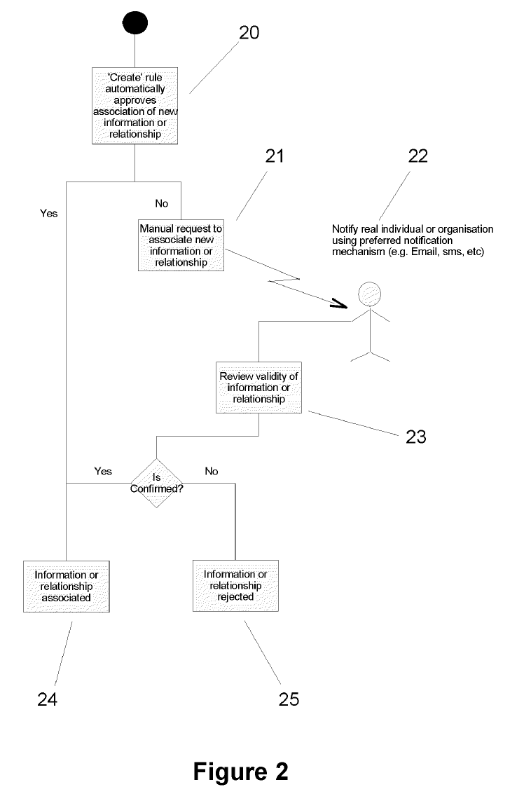

The first ‘right’ is the ability to create (or associate) new information or a relationship with the target. This will involve confirming with the target (12) that it is acceptable to associate the new information or relationship. This ensures that no unauthorised information becomes associated with the target without the appropriate prior approval of the target. The mechanism used to interact with the target, to obtain the appropriate approval or rejection of the new information/relationship, is discussed later, with reference to FIG. 2.

If the target confirms that the new information/relationship is valid and agrees that it can be associated, then the information/relationship will become associated with the target (13), along with the access control rules that will govern subsequent access to that information by other entities.

This confirmation may occur almost immediately, if approved using pre-configured rules, or it may take time, if dependent on an individual or organisation (associated with the target entity) to manually authorise the association. It may be relevant for the individual/organisation requesting the association of the information/relationship to specify a timeout period, thereby avoiding waiting indefinitely for the confirmation.

The second ‘right’ is the ability to read information/relationships associated with the target. This ‘right’ will be subject to access control rules (14) being applied to the virtual representation of the requesting entity, to ensure that the requesting individual/organisation (or anonymous) has appropriate access rights to the requested information/relationship. If they are deemed to have access privileges, then the information/relationship will be retrieved (15). This information may also be encrypted, but this will be passed back to the requesting individual/organisation for decryption.

The third ‘right’ is the ability to modify information/relationships associated with the target. As with reading, this ‘right’ will be subject to validation of the access privileges (16) using access control rules applied to the requesting entity's virtual representation. If access is permitted, then the relevant information/relationship will be updated (17).

The final ‘right’ is the ability to delete information/relationships associated with the target. As with reading and updating, this ‘right’ will be subject to validation of the access privileges (18) using access control rules applied to the requesting entity's virtual representation. If access is permitted, then the relevant information or relationships will be removed (19).

It may be the case that even the target entity will not have access privileges to read, update or delete some information or relationships associated with itself. For example, this would be the case with government associated information (e.g. health records).

Access control rules will only be relevant where the requesting entity (individual or organisation) did not create (or associate) the information with the target entity. If the requesting entity is the creator (or owner of the information), then they have full rights to read, update and delete the information without the access control rules being applied.

Confirmation of Information/Relationship Association

FIG. 2 shows the procedure for obtaining approval, regarding a request to associate new information or relationship with a target, namely the individual or organisation being acted upon. This step was referenced in FIG. 1 at (12).

The first stage (20) is to determine whether a pre-configured ‘create’ rule exists, associated with the target, that can automatically approve the association of the information or relationship. If a suitable rule is found, then the information/relationship will be associated with the target (24).

If a suitable ‘create’ rule does not exist, then a manual authorisation approach (21) will be used, which involves notifying (22) the individual or organisation associated with the target that such a request has been made. This notification will be sent using one or more preferred notification mechanisms (e.g. email or SMS) that have previously been configured with the target's virtual representation. This preference information would be publicly accessible information, associated with the target, that the target defined on their own representation. This information would be only modifiable by the target.

The target would then access their representation to review the details associated with the pending information/relationship association request (23). If they approve the request, then the information or relationship will be associated with the target (24). If they refuse the request, then the information or relationship will not be associated with the target (25).

Due to the potential time delay between a request being made, and the target reviewing the request, an expiry mechanism may be used to prevent requests remaining indefinitely in a pending state. It may also be appropriate to notify the requesting individual or organisation when a request has either been approved, rejected or expired.

Globally Federated and Replicated Servers and Data Stores

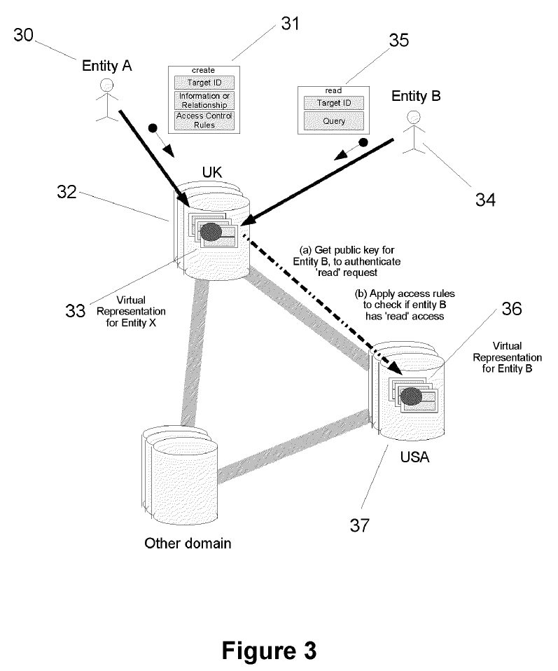

FIG. 3 shows the globally federated servers and data stores that would be used to provide storage and access to the virtual representations, of individuals and organisations, and the information and relationships associated with them. The architecture would be expected to have replicated servers for resilience and load balancing purposes.

An individual or organisation (30), labelled Entity A, would make a request to the servers, which could be to associate new information, read existing information/relationships, update existing information/relationships or delete information/relationships.

In FIG. 3, Entity A (30) is creating new information (31) by specifying the unique identifier of the virtual representation of the target, Entity X (33), the information or relationship details, and the access control rules that should be applied to any subsequent request for access to this information/relationship details. The access control rules would be specific to the operations that may be performed (e.g. read, update and delete). Only Entity A (30), that is creating (and therefore ‘owns’) the information, would not be subject to the access control rules when making subsequent read, update or delete requests related to the created information/relationship.

The request (31) would be directed to the relevant domain that is responsible for Entity X. In this case, Entity X is a citizen of the UK, and therefore the request is sent to the UK managed domain (32) within the federated architecture. Once the individual or organisation related to Entity X (33) has approved the new information or relationship, it will be associated with it's virtual representation.

Subsequently, Entity B (34) makes a ‘read’ request (35) for information associated with Entity X (33). The first step will be to verify the identity of Entity B. One embodiment may use digital signature technology to authenticate the request from Entity B, against a public key recorded with Entity B's virtual representation (36).

If the query in the read request (35) requires access to the information or relationship previously created by Entity A (31), then the access control rules supplied by Entity A in the create request (31) will be applied to information and relationships associated with Entity B's virtual representation (36).

In FIG. 3, Entity B's virtual representation (36) is managed by the USA domain (i.e. they may be citizen or legal entity within the USA). Therefore the request for public key, to authenticate Entity B, or the request for information to apply the access control rules, will be routed through the federated architecture to the appropriate managed domain (37).

To overcome concerns with the security of information being managed within this globally distributed architecture, one embodiment of the architecture may make governments responsible for managing the infrastructure used to store the virtual representations of the individuals and organisations within their domain of control. Therefore, as illustrated in FIG. 3, the servers and data stores associated with (32) may be managed by United Kingdom Government, and the servers and data stores associated with (37) may be managed by USA Government. However, this is a simplified view, as each country may have further segmentation of the information into regions, with management authorities responsible for each region.

The other security concern may relate to the authenticity of a virtual representation. One embodiment of the invention may make a government agency within each domain responsible for the creation of virtual representations, suitably initialised to reflect the “guarantee of validity” as being a citizen (or legal entity) of the relevant country. This guarantee can be used in situations where it is appropriate to check that the virtual representation represents a real person or company and that their identity has not been fraudulently copied (for example when applying for a credit card).

Another concern may be how the cost of such infrastructure could be funded. With the approach outlined here, many organisations will no longer have the burden of storing a large volume of information. Therefore, in place of purchasing and managing their own storage facilities, they would be charged a storage fee related to the amount of information being stored with the virtual representations. Charges may only be applicable for larger quantities of information, to enable small amounts of useful information to be associated with virtual representations without incurring costs. However, larger amounts of information usually equate to some commercial benefit. Therefore, in most cases, the organisation (or individual) recording the information should be charged a suitable fee to offset the cost of managing the information.

Creating a New Virtual Representation

Due to the ‘official’ status that a virtual representation may have, whether it represents an individual or an organisation, it may be appropriate for a government agency to be responsible for creating the virtual representations of the individuals or organisations within its domain. This ensures that the identity of the virtual representation cannot be forged or fraudulently used. The virtual representation would have the appropriate ‘government seal of approval’ information associated with it, which is signed by the government so that it can be authenticated by anyone interested in validating the virtual representation.

The procedure for an individual would be as follows:

1) When a child is born, as part of the registration procedure the details will be provided to the relevant government agency.

2) Once the agency are satisfied regarding the validity of the details, and have the appropriate associations with the virtual representations of the child's parents, then a new virtual representation will be created.

3) Relevant government information will be associated with the virtual representation, being signed and encrypted where appropriate.

4) An initial National Health record will be recorded with the virtual representation, with access privileges to enable health agencies to update the details, but prevent the individual from being able to read, modify or delete the record.

5) Once all relevant information has been established, the reference to the child's virtual representation will be made publicly accessible, and notified to the parents.

A similar procedure would occur for organisations that are established within the administrative responsibility of a government. The government would associate relevant information with the virtual representation, and over the life of the organisation, its accounts and other appropriate details will be added to its virtual representation by the relevant government agency.

Getting a New Credit Card

By way of an example, we now consider the application of the invention to the situation where an individual obtains a new credit card. The procedure for an individual, represented by a virtual entity within the globally accessible repository, to obtain a new credit card would be as follows:

1) The individual obtains a reference to their virtual entity (representation).

2) The individual signs the reference with their private key.

3) The signed reference is passed to the credit card company.

4) The credit card company authenticate that the reference belongs to the requesting individual, by verifying the signed reference against the individual's public key.

5) The credit card company create a new account.

6) The credit card company signs and encrypts the account details, and then requests to associate the details with the individual's virtual representation.

7) The individual gets notification that a credit card company wishes to associate details with them, where the details are authenticated as being provided by the credit card company.

8) The individual accepts the new details, but is unable to read or modify them. This step is equivalent to the individual's final acceptance of the credit card account and its associated terms and conditions. The individual could equally decide to reject the association of the new details from the credit card company, which would be taken to mean a cancellation of the credit card application.

A benefit of using this approach is that it is possible that even the individual associated with the new credit card account would not know the account details, as this information is actually only of use (and meaningful to) the credit card issuer.

Buying Goods With a Credit Card

We now consider the application of the invention to the situation where an individual buys goods with a credit card. The procedure would then be as follows:

1) The individual will access a website to select some goods for purchase.

2) When appropriate, the individual will provide a reference to their virtual entity (representation), signed with their private key, to enable the website to authenticate the individual using the public key associated with the individual's virtual representation.

3) When the individual has selected the items to purchase, the website will build the transaction information, containing the website organisation's (virtual representation) reference, transaction amount and customers (i.e. individual) reference, and then digitally sign the message before sending it to a payment processor.

4) Payment processor confirms the authenticity of the message against the website organisation's public key.

5) Next the payment processor confirms with the individual, using the individual's authenticated reference, that they wish to proceed with the purchase, by sending a message via the individual's virtual representation.

6) If the individual responds to the payment processor indicating it should proceed, by digitally signing the transaction details (possibly containing a unique reference from the payment processor to avoid duplicate responses), then the payment processor would obtain the private credit card details (only readable by itself) that are associated with the individual's virtual representation.

7) Once the transaction has been completed, the payment processor will notify the website organisation of the outcome using a digitally signed transaction confirmation.

8) The website organisation would then retrieve the delivery address information from the individual's virtual representation, along with any other website specific private information they have recorded against the individual. If the website records frequent buyer points (for example), then it would update this information in its website specific information associated with the individual—this information may be used to give the individual a discount the next time they purchase goods, or for directed advertising.

There are a number of issues to be considered in relation to this type of interaction, as follows:

a) Communications between the virtual entities (i.e. individual, website organisation and payment processor) could be via their virtual representations, or via traditional websites with the relevant references being passed as part of the exchanged messages.

b) If an individual has more than one credit card that is available to the payment processor, then the individual may be requested to select which card to use for the transaction.

c) The payment processing company may not be the same company that issued the credit card account, but has the authority to access the private information recorded by the credit card company based on being a trusted subsidiary or partner of the credit card company.

d) Approach can be based on well established authentication and encryption techniques. Unique aspect is the centralisation of information about individuals, and the protected access to relevant information associated with the individual by third parties.

e) Confirmation with the individual, in the above example, may be required to prevent the website organisation submitting multiple payment requests, using the same signed individual details provided in a previous valid transaction.

There are also a number of benefits associated with this approach. Firstly, the supplier (website organisation) and individual do not need to know the credit card account details to be able to conduct the transaction. Secondly, secure communications, based on the virtual representations, can be used to ensure an individual actually confirms financial transactions being conducted in their name. This prevents a fraudulent transaction being attempted by someone who manages to copy a signed version of an individual's reference to pretend to be that person.

Secure Email

Another application of the present invention is to emails. It is currently possible to digitally sign emails and decide to only receive emails that are signed. However, this does not identify anything about the sender, only that they have obtained a digital signature from a suitable trusted party.

In contrast, using the present invention, a virtual representation of an individual could indicate that they will only accept emails from other virtual individuals or organisations that have been suitably endorsed by a government agency as being valid. This endorsement could be in terms of being a valid limited company, or having a national insurance/social security number. These endorsements would only be associated with the individual by a government agency, and therefore could not be forged.

If an unwanted person sent an email, the target individual could then decide to block them from then on. Thereafter, it would be difficult for that person to find an alternative way to send further unwanted messages. It would no longer be easy for people to simply create new email addresses, once old ones have been blacklisted, as they would only have one ‘officially endorsed’ identity.

Health Care Records

A further application of the present invention is to official records. For example, in a similar manner to the credit card details, an individual's health records could be associated with their virtual representation, but protected so that the individual cannot read, write or delete them.

The health care authority (e.g. the NHS in the UK) could be the overall authority associated with the health care records for individuals within their responsibility, and therefore are able to read and write information to those records.

However individual departments, or organisations within the health service, also need to be able to read and write information to an individual's records, occasionally being protected against other departments within the health service. The authorisation to read and write information could be based on privileges associated with the hierarchy within the health service. For example, two departments within a hospital may be able to read and write information associated with the hospital and the overall health service, but only able to read information associated with each others departments.

However, some information associated with the overall health authority may not be writable by any sub-departments. For example, the unique national health number for an individual can only be assigned by the overall health authority.

A benefit of the present invention is that relationships can enable sub-authorities to be established that inherit rights from their parent authorities, allowing them to access and potentially write information associated with the parent authority.

Accessing a Bank Account

A still further application of the present invention is to managing a bank account. There are two ways in which a bank account could be managed in conjunction with the invention.

In the first method, bank account details are associated with the individual's virtual representation. As with any information associated with an individual, the bank could decide to associate the bank account details for the individual with their virtual representation, as private data only read and writable by the bank. If the individual wishes to view or transact with their bank account, they must access the bank's website, which will then read the information from the individual's virtual representation—i.e. indirect lookup using the access privileges of the bank.

In the second method, bank account details are held by the bank, which is the current approach used by all banks. However, in the context of the present invention, where individuals have virtual representations and authenticate themselves using public/private keys, it is more likely that an individual's bank account will be accessible using the public/private key authentication, as opposed to username, password and PINs as now.

With either approach the bank website would need to produce a challenge that the individual would sign using their private key. This would ensure that a third party could not fraudulently obtain a previously signed copy of some non-random information and use it to access the bank account details.

Value Added Application—School Management System

In addition to all the applications described above, there are uses of higher level information in relation to the present invention. In particular, having individuals and other entities modelled within a centralised repository, with suitable relationships between them, means that it is possible to build applications that operate on the information.

One such example application is related to management of schools, where relationships may exist between parents and children, children to their school, teachers to the school where they teach, teachers with their classes, and teachers with their form group.

With such information being modelled, it is possible to build applications that could perform the following tasks:

a) A teacher wishes to send a letter to all the parents of their form children. An application could query the form associated with the teacher, to obtain a list of pupils (i.e. their virtual representations) and then return the parent(s) (i.e. virtual representations) associated with each of the pupils. Using the communication mechanism associated with the virtual representation of the parent, it would then be possible to send the letter.

b) A students academic record is associated with their virtual representation and only updateable by academic institutions, but can be read by anyone. If the student transfers to another institution, whether due to moving area, or going into further education, then their record would accompany them.

c) A student can have a calendar associated with their virtual representation for education purposes, which can be updated by their current academic institution to include educational activities, or homework, which can then be read only by the student and their parents.

d) Using test results for the children within a particular year, a school could place the pupils into sets for each subject and assign the sets to rooms in the school. This can be achieved by modelling the rooms and other relevant resources associated with the school, so that there is an understanding of the schedules associated with the pupils and rooms.

As will be apparent to the skilled person, this shows that modelled information can be used by higher level applications, whether it be to solve localised problems, such as scheduling sets and rooms within a school, or for wider tasks, such as comparing the achievements of students in a specific region. The flexibility afforded by the present invention means that the situations in which the invention can be employed to beneficial effect are almost unlimited.

1. A computer implemented method of governing access to data stored in an electronic data store, comprising the steps of:
receiving from a first entity the data and a set of access control rules to govern access rights to the data; and,
storing the data together with the set of access control rules in the electronic data store, such that any subsequent attempt to access the stored data is governed by access control rules in the stored set associated with the stored data.

2. A method according to claim 1, further comprising the steps of:
subsequently receiving a request from a second entity for access to the data in the data store; and,
granting to the second entity access rights to the data in accordance with access control rules in the stored set associated with the data in dependence on information associated with the second entity.

3. A method according to claim 2, wherein the information associated with the second entity is directly associated with the second entity.

4. A method according to claim 2, wherein the information associated with the second entity is indirectly accessible via relationships associated with the second entity.

5. A method according to claim 2, wherein the second entity is the first entity and full access rights are granted to the first entity.

6. A method according to claim 1, wherein the access rights to the data governed by the set of access control rules include data read, update and delete rights.

7. A method according to claim 1, wherein the set of access control rules is recorded with a record in a relational database (RDBMS).

8. A method according to claim 1, wherein the set of access control rules is bound to an object stored within an object database (ODBMS).

9. A method according to claim 1, wherein the stored data and access control rules are associated with a virtual representation of a third entity.

10. A method according to claim 9, wherein the third entity is an individual person.

11. A method according to claim 9, wherein the third entity is an organisation.

12. A method according to claim 9, further comprising the steps of:
subsequently receiving a request from the third entity for access to the data in the data store; and,
granting to the third entity access rights to the data in accordance with access control rules in the stored set associated with the data in dependence on information associated with the third entity.

13. A method according to claim 9, wherein the virtual representation is referenced by means of a unique identifier.

14. A method according to claim 13, wherein the virtual representation is referenced by means of a universal resource locator (URL) over a communications network.

15. A method according to claim 13, wherein the unique identifier is obtainable by means of a query based on public information in the virtual representation of the third entity.

16. A method according to claim 9, wherein the stored data represents relationships between the virtual representation of a third entity and virtual representations of other entities.

17. A method according to claim 9, wherein the virtual representation of the third entity is one of many virtual representations of different entities managed by a fourth entity within a globally accessible and federated information store.

18. A method according to claim 9, wherein the virtual representation of the third entity is created by an official agency.

19. A method according to claim 9, further comprising the steps of:
subsequently receiving a request from another entity to associate further data with the virtual representation of the third entity; and,
granting to the other entity create rights to associate the further data and any related access control rules with the virtual representation of the third entity in accordance with create rules associated with the virtual representation of the third entity.

20. A method according to claim 19, wherein the further data represents relationships between the virtual representation of the third entity and virtual representations of other entities.

21. A method according to claim 19, wherein if no create rules apply the method further comprises the step of contacting the third party for manual approval to associate the further data and any related access control rules with the virtual representation of the third party.

22. A system for managing and providing access to virtual representations of entities, the system comprising:
a plurality of globally federated and replicated servers, the servers being located in one or more different domains;
a plurality of data stores associated with the servers, the data stores being located in the one or more different domains,
wherein the plurality of servers and data stores are adapted to implement the method according to claim 17.

23. A system according to claim 22, wherein the different domains are different national jurisdictions and the servers and data stores located in each different national jurisdiction are managed by an official agency of that national jurisdiction.
